(19) United States
(12) Patent Application Publication
(10) Pub. No.: US 2005/0221876 A1
(43) Pub. Date: Oct. 6, 2005

(54) Methods for sending messages based on the location of mobile users in a communication network

(76) Inventors: James A. Van Bosch, Crystal Lake, IL (US); Michael A. Newell, Williams Bay, WI (US); Robert F. D'Avello, Lake Zurich, IL (US); Nick J. Grivas, Harvard, IL (US); Jerome D. Meyerhoff, Buffalo Grove, IL (US); Scott B. Davis, Walworth, WI (US)

Correspondence Address: MOTOROLA, INC., 1303 EAST ALGONQUIN ROAD, IL01/3RD, SCHAUMBURG, IL, 60196, US

(21) Appl. No.: 10/818,078

(22) Filed: Apr. 5, 2004

(51) Int. Cl. H04Q 7/20

(52) U.S. Cl. 455/575.9

(57) ABSTRACT

A system and procedure for posting and receiving location-based messages in a wireless communication based network. The system allows messages to be posted to specified users and to be associated with a particular location for which the message is pertinent. The messages can be left when a user passes a particular location, or the user can specify the location for the message even if not present at that location. The messages can then be displayed at a user interface of the recipient either when the recipient nears that location, or they can be reviewed in advance. Such location-based messages can be left either for another user or for the same user that is posting the method. The posted and received messages can be textual, audio, video, or pictorial messages and may be superimposed on computerized maps to make association between the message and the location more meaningful. Regardless, the disclosed system and methods allow messages to be associated with particular locations of interest.

The present application is related to the following co-pending, commonly assigned patent applications, which were filed concurrently herewith and incorporated by reference in their entirety:
Ser. No. ______, entitled “Selectively Enabling Communications at a User Interface Using a Profile,” attorney docket TC00167, filed concurrently herewith.
Ser. No. ______,entitled “Method for Enabling Communications Dependent on User Location, User-Specified Location, or Orientation,” attorney docket TC00168, filed concurrently herewith.
Ser. No. ______, entitled “Methods for Displaying a Route Traveled by Mobile Users in a Communication Network,” attorney docket TC00170, filed concurrently herewith.
Ser. No. ______, entitled “Conversion of Calls from an Ad Hoc Communication Network,” attorney docket TC00172, filed concurrently herewith.
Ser. No. ______, entitled “Method for Entering a Personalized Communication Profile Into a Communication User Interface,” attorney docket TC00173, filed concurrently herewith.
Ser. No. ______, entitled “Methods and Systems for Controlling Communications in an Ad Hoc Communication Network,” attorney docket TC00174, filed concurrently herewith.
Ser. No. ______, entitled “Methods for Controlling Processing of Inputs to a Vehicle Wireless Communication Interface,” attorney docket TC00175, filed concurrently herewith.
Ser. No. ______, entitled “Methods for Controlling Processing of Outputs to a Vehicle Wireless Communication Interface,” attorney docket TC00176, filed concurrently herewith.
Ser. No. ______, entitled “Programmable Foot Switch Useable in a Communications User Interface in a Vehicle,” attorney docket TC00177, filed concurrently herewith.

### FIELD OF THE INVENTION

This invention relates to systems and methods for sending and receiving location-based messages in a communication network.

### BACKGROUND OF THE INVENTION

Communication systems, and especially wireless communication systems, are becoming more sophisticated, offering consumers improved functionality to communicate with one another. Such increased functionality has been particularly useful in the automotive arena, and vehicles are now being equipped with communication systems with improved audio (voice) wireless communication capabilities. For example, On Star™ is a well-known communication system currently employed in vehicles, and allows vehicle occupants to establish a telephone call with others (such as a service center) by activating a switch.

Existing vehicle-based communication systems, however, contemplate immediate communication between the two parties, which may not always be desirable. For example, an occupant in a first vehicle may wish to remind a second vehicle of something at a particular time and/or at a particular location along the second vehicle's route. For example, the first vehicle may wish to post a reminder message to the second vehicle to have the user “turn right here, at Autumnway Drive, and pull into the diner to meet me.” It may also be desired for a first user to leave a similar location-based message for the second vehicle even when that first user is not in a vehicle or not mobile. For example, the first user may wish from his home to leave a similar message for the second vehicle, such as “turn into the grocery store here and bring home a bottle of milk on your way home from work.” Such messages are thus only relevant to the second vehicle when they are at or near the particular locations, and furthermore may only have pertinence at a particular time or day. Such functionality is not presently enabled in vehicle-based or other communication systems.

It is, therefore, desirable to provide an improved vehicle communication system that includes the sending and receiving location-based messages. In particular, it would thus be convenient for vehicle-based (or other) communication systems to allow messages to be left for a second user at a particular location and further at a particular time or date. This disclosure presents several different means for meeting these needs.

### BRIEF DESCRIPTION OF THE DRAWINGS

FIG. 1 is a block diagram of a wireless vehicular communications system;

FIG. 2 is a block diagram of a control system for a vehicular wireless communications system;

FIG. 3 is diagram illustrating a map showing two vehicles and a house in communication with a system in which location-based messages can be posted and received;

FIGS. 4a-4d are embodiments of a user interface for posting a location-based message for a user of the communication system;

FIG. 5 is a block diagram of a further embodiment of a control system with the addition of a video camera to allow the posting of video messages;

FIG. 6 is a diagram illustrating two vehicles in wireless communication and the transmission and storage of a location-based message from one vehicle to the other;

FIG. 7 illustrates one embodiment of a display in a user interface for reviewing a textually-based location-based message;

FIG. 8 illustrates one embodiment of a display in a user interface for reviewing a location-based message superimposed on a map marked with the location;

FIG. 9 illustrates one embodiment of a display in a user interface for reviewing a plurality of location-based messages superimposed on a map marked with the locations;

FIG. 10 illustrates one embodiment of a display in a user interface for reviewing a plurality of textually-based location-based messages;

FIG. 11 illustrates one embodiment of a display in a user interface for reviewing a plurality of audio or video-based location-based messages; and

FIG. 12 illustrates one embodiment of a monitor in the computer for posting a location-based message to a mobile user.

While the invention is susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the appended claims.

### DETAILED DESCRIPTION

What is described is a system and method for sending and receiving location-based messages in a communication network. The system allows messages to be posted to specified users and to be associated with a particular location for which the message is pertinent. The messages can be left when a user passes a particular location, or the user can specify the location for the message even if not present at that location. The messages can then be displayed at a user interface of the recipient either when the recipient nears that location, or they can be reviewed in advance. Such location-based messages can be left either for another user or for the same user that is posting the method. The posted and received messages can be textual, audio, video, or pictorial messages and may be superimposed on computerized maps to make association between the message and the location more meaningful. Regardless, the disclosed system and methods allow messages to be associated with particular locations of interest.

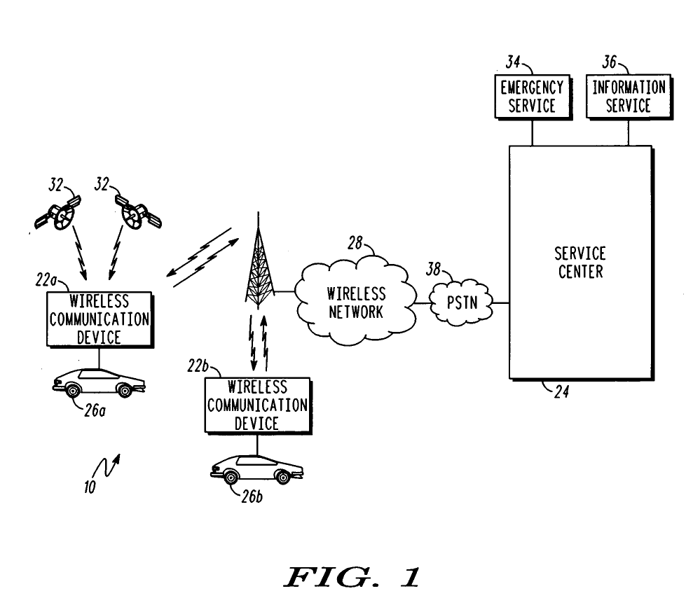

Now, turning to the drawings, an example use of the present invention in an automotive setting will be explained. FIG. 1 shows an exemplary vehicle-based communication system 10. In this system, vehicles 26 are equipped with wireless communication devices 22, which will be described in further detail below. The communication device 22 is capable of sending and receiving voice (i.e., speech), data (such as textual or SMS data), and/or video. Thus, device 22 can wirelessly transmit or receive any of these types of information to a transceiver or base station coupled to a wireless network 28. Moreover, the wireless communication device may receive information from satellite communications. Ultimately, the network may be coupled to a public switched telephone network (PSTN) 38, the Internet, or other communication network on route to a server 24, which ultimately acts as the host for communications on the communication system 10 and may comprise a communications server. As well as administering communications between vehicles 26 wirelessly connected to the system, the server 24 can be part of a service center that provides other services to the vehicles 26, such as emergency services 34 or other information services 36 (such as restaurant services, directory assistance, etc.).

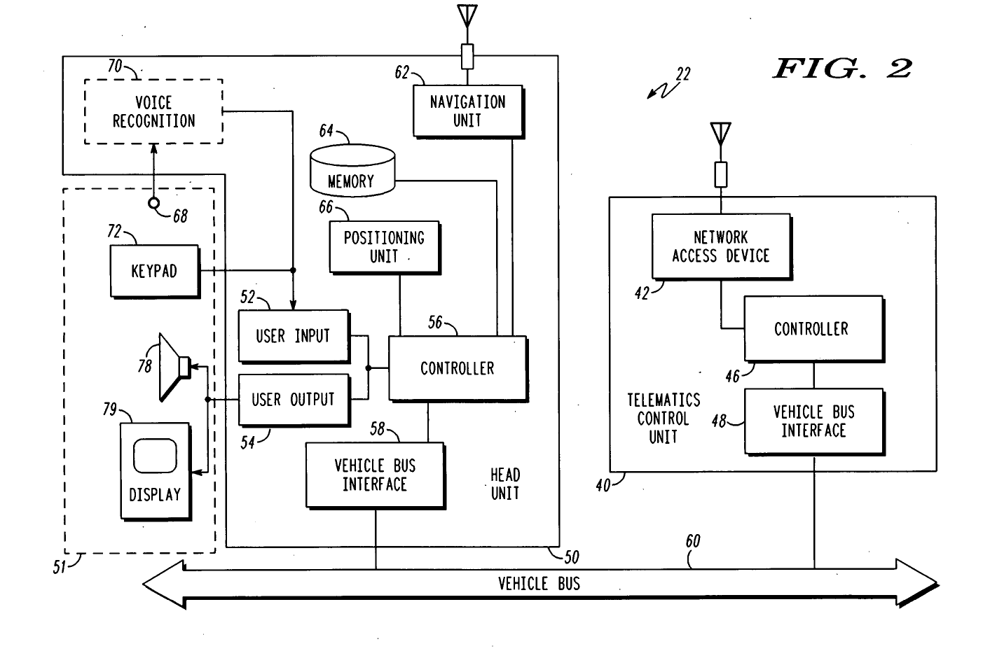

Further details of a typical wireless communications device 22 as employed in a vehicle 26 are shown in FIG. 2. In one embodiment, the device 22 is comprised of two main components: a head unit 50 and a Telematics control unit 40. The head unit 50 interfaces with or includes a user interface 51 with which the vehicle occupants interact when communicating with the system 10 or other vehicles coupled to the system. For example, a microphone 68 can be used to pick up a speaker's voice in the vehicle, and/or possibly to give commands to the head unit 50 if it is equipped with a voice recognition module 70. A keypad 72 may also be used to provide user input, with switches on the keypad 72 either being dedicated to particular functions (such as a push-to-talk switch, a switch to receive mapping information, etc.) or allowing for selection of options that the user interface provides.

The head unit 50 also comprises a navigation unit 62, which typically includes a Global Positioning Satellite (GPS) system for allowing the vehicle's location to be pinpointed, which is useful, for example, in associating the vehicle's location with mapping information the system provides. As is known, such a navigation unit communicates with GPS satellites (such as satellites 32) via a receiver. Also present is a positioning unit 66, which determines the direction in which the vehicle is pointing (north, north-east, etc.), and which is also useful for mapping a vehicle's progress along a route.

Ultimately, user and system inputs are processed by a controller 56 which executes processes in the head unit 50 accordingly, and provides outputs 54 to the occupants in the vehicle, such as through a speaker 78 or a display 79 coupled to the head unit 50. The speakers 78 employed can be the audio (radio) speakers normally present in the vehicle, of which there are typically four or more, although only one is shown for convenience. Moreover, in an alternative embodiment, the output 54 may include a text to speech converter to provide the option to hear an audible output of any text that is contained in a group communication channel that the user may be monitoring. This audio feature may be particular advantageous in the mobile environment where the user is operating a vehicle. Additionally, a memory 64 is coupled to the controller 56 to assist it in performing regulation of the inputs and outputs to the system. The controller 56 also communicates via a vehicle bus interface 58 to a vehicle bus 60, which carries communication information and other vehicle operational data throughout the vehicle.

The Telematics control unit 40 is similarly coupled to the vehicle bus 60, via a vehicle bus interface 48, and hence the head unit 50. The Telematics control unit 40 is essentially responsible for sending and receiving voice or data communications to and from the vehicle, i.e., wirelessly to and from the rest of the communications system 10. As such, it comprises a Telematics controller 46 to organize such communications, and a network access device (NAD) 42 which include a wireless transceiver. Although shown as separate components, one skilled in the art will recognize that aspects of the head unit 50 and the Telematics control unit 40, and components thereof, can be combined or swapped.

The wireless communications device 22 can provide a great deal of communicative flexibility within vehicle 26. For example, an occupant in a first vehicle 26a can call a second vehicle 26b to speak to its occupants either by pressing a switch on the keypad 72 of the head unit 50 or by simply speaking if the head unit is equipped with a voice recognition module 70. In one embodiment, the pressing of a switch or speaking into a voice recognition module initiates a cellular telephone call with a second vehicle 26b. In this case, users in either the first vehicle 26a or the second vehicle 26b can speak with each other without pressing any further switches. Moreover, the system may be configured to include a voice activated circuit such as a voice activated switch (VAS) or voice operated transmit (VOX). This would also provide for hands-free operation of the system by a user when communicating with other users.

In an alternative embodiment, the switch may be configured to establish a push-to-talk communication channel over a cellular network. Here, the controller 56 is configured to only allow audio by occupants in the first vehicle 26a through microphone 68 to be transmitted through the Telematics control unit 40 when a user in the first vehicle 26a is pressing down on the push-to-talk switch. The controller 56 is further configured to only allow audio received from the second vehicle 26b (or server 24) to be heard over speakers 78 when the operator of the first vehicle 26a is not pressing down on the switch. Alternatively, to avoid the need of holding down a switch to speak, the system may be configured to allow a user to push a button a first time to transmit audio and push the button a second time to receive audio.

In any event, a user in the second vehicle 26b can, in like fashion, communicate back to the first vehicle 26a, with the speaker's voice being heard on speaker(s) 78 in the first vehicle. Or, an occupant in the first vehicle 26a can call the server 24 to receive services. Additionally, such a system 10 can have utility outside of the context of vehicle-based applications, and specifically can have utility with respect to other portable devices (cell phones, personal data assistants (PDAs), etc.).

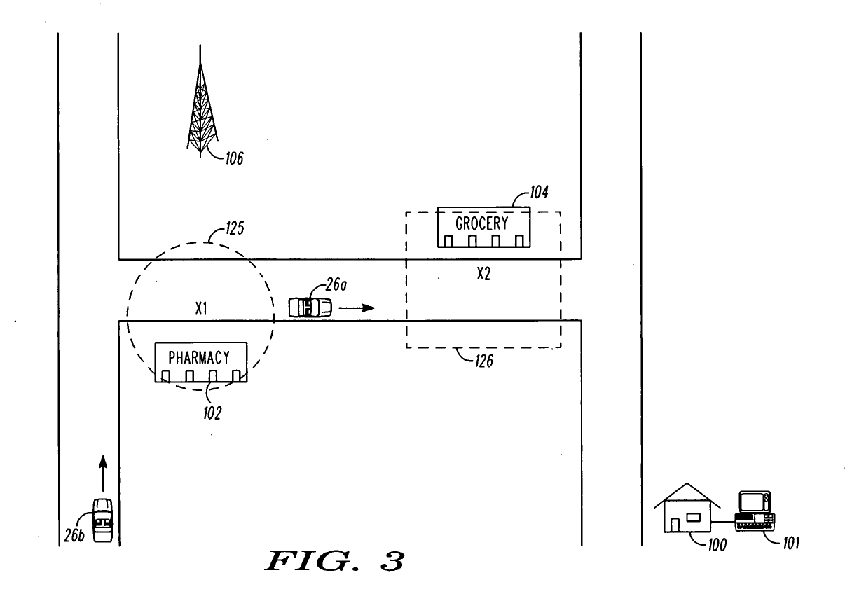

FIG. 3 illustrates two traveling vehicles 26a and 26b. Also illustrated is a house 100 having a personal computer 101 therein, and two stores: a pharmacy 102 and a grocery 104. Also illustrated is a transceiver tower or base station 106 which forms part of the communications network 10 as largely illustrated in FIG. 1. The vehicles 26a and 26b are in wireless communication with the system 10.

In a first embodiment, the first vehicle 26a desires to leave a message for the second vehicle 26b, in this case, instructing the second vehicle to stop at the pharmacy 102 to pick up a prescription. In this first embodiment, the message is left at the current location of the first vehicle 26a which is leaving the message. Thus, in this embodiment, assume that the vehicle 26a was at a prior time at location X1 (i.e., at or just before the pharmacy) when the first vehicle posted the message for the second vehicle 26b.

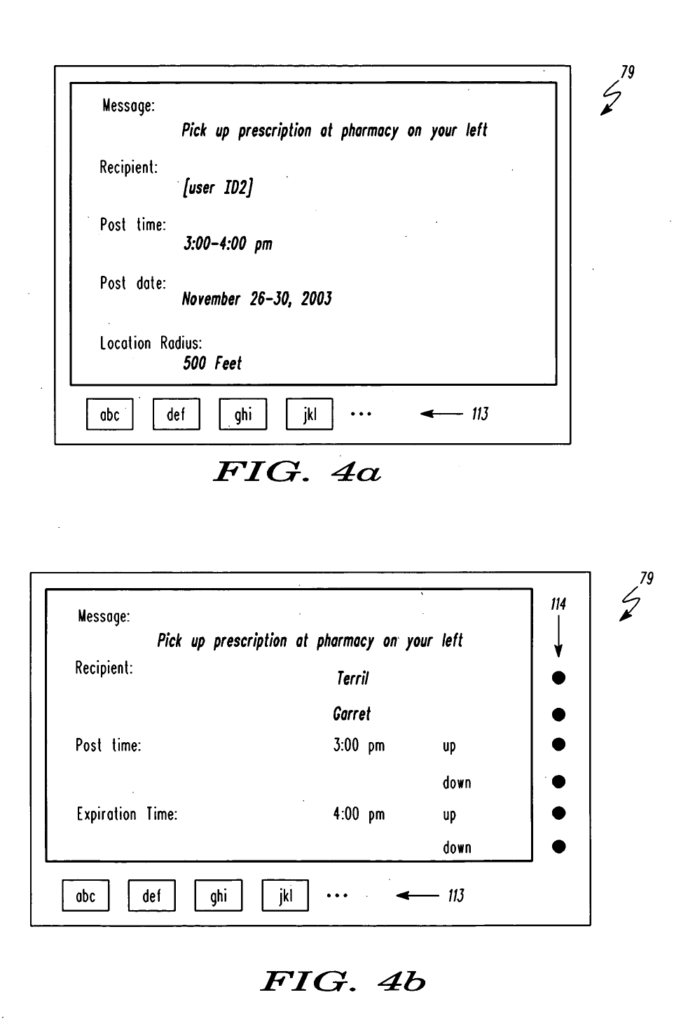

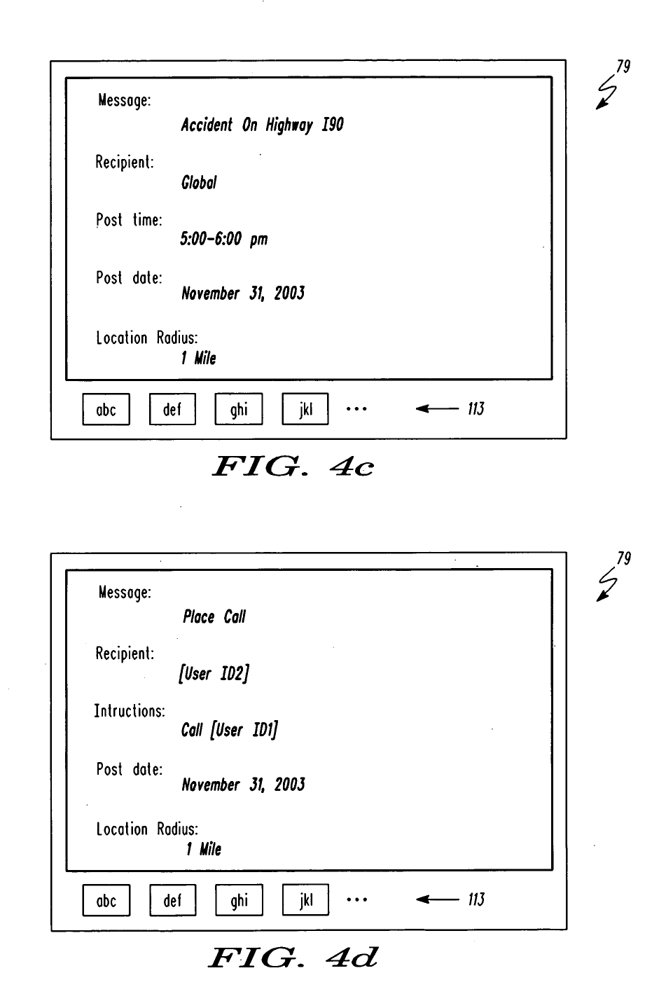

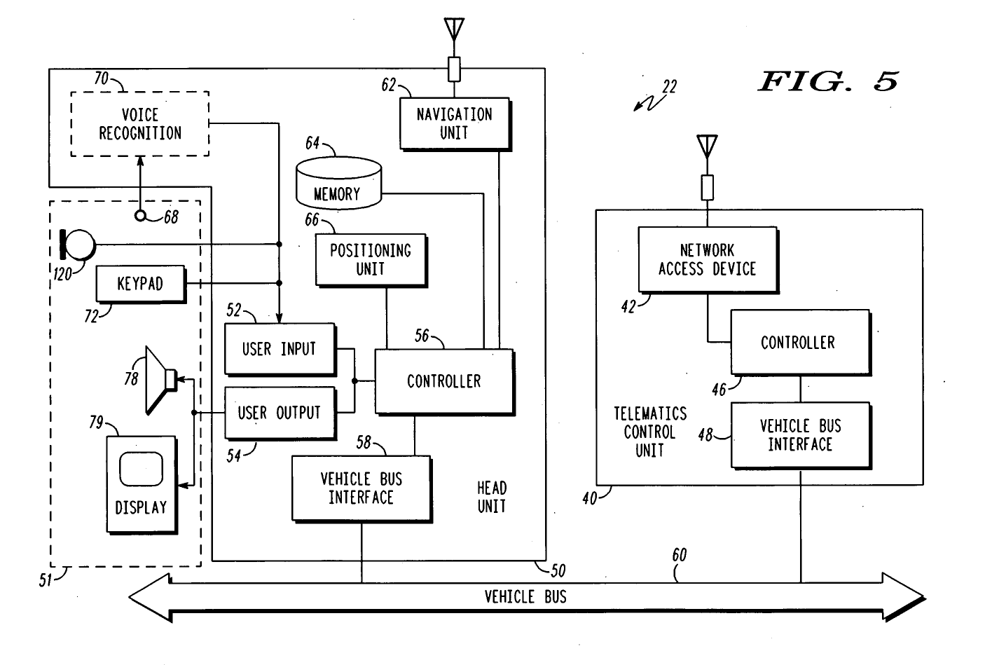

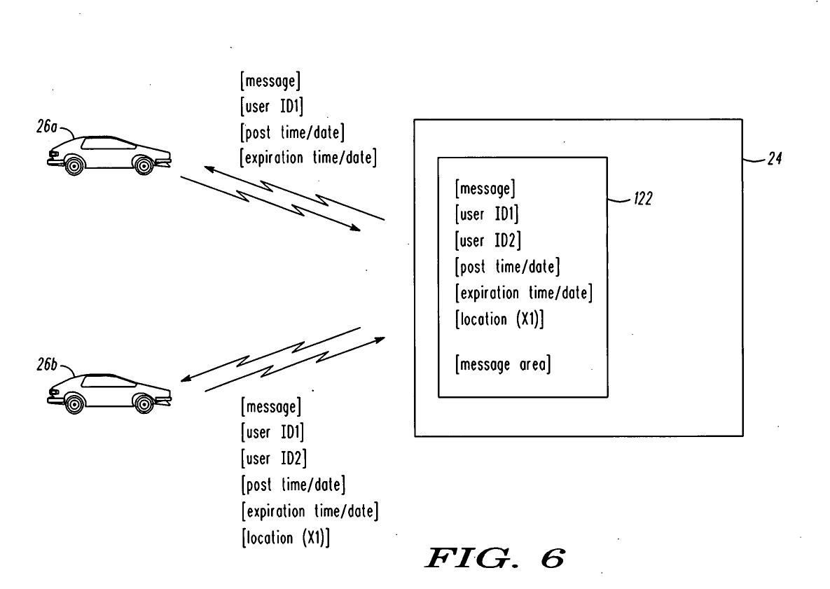

The first vehicle 26a can leave the message for the second vehicle 26b in a number of different ways using the user interface 51 in the first vehicle. FIG. 4a illustrates one method using the display 79 and other aspects of the user interface 51. In this example, an occupant in the first vehicle 26a can enter the message and other pertinent information concerning the message using switches 113 on the user interface 51 in the vehicle, which in this example would be similar to schemes used to enter names and numbers into a cell phone. The recipient information preferably constitutes a user ID for an occupant in the second vehicle 26b which is recognizable by the system. Because the message may also have pertinence to a particular time of day, or time period during the day, or a particular day, or day of the week, the first vehicle 26a can also specify the dates and times at which the message should be transmitted to the second vehicle 26b. For example, if the message refers to an item that the second vehicle needs to pick up at a store after work, receipt of the message at a particular time of day (3:00-4:00 pm) may be the only pertinent time at which the message need be transmitted, and the first vehicle can so designate. Accordingly, the posting and expiration dates, time, periods, are specifiable.

Of course, many other less cumbersome ways may be used to textually enter the message and other information. For example, in FIG. 4b, other switches 114 on the user interface 51 are used to allow other message information to be easily selected without substantial typing on behalf of the first vehicle's occupant. Thus, those users in the second vehicle which are normally contacted by the users in the first vehicles can be loaded from memory 64 and correlated with switches 114 for easy selection. Similarly, the post time and expiration time for the message can be more easily entered using certain switches 114 as up/down buttons to adjust the time. (The post and expirations dates can be similarly adjusted in this fashion, although this is not shown). The disclosed schemes of FIGS. 4a and 4b are merely illustrative.

FIG. 4c illustrates another method using the display 79 and other aspects of the user interface 51. In this example, an occupant in the first vehicle 26a can enter a global message and other pertinent information concerning the message using switches 113 on the user interface 51 in the vehicle, which in this example would be a global message to other users regarding an accident. The recipient information preferably constitutes people that may be affected by the message (even broadly defined as global). Because the message may also have pertinence to a particular time of day, or time period during the day, or a particular day, or day of the week, the first vehicle 26a can also specify the dates and times at which the message should be transmitted to anyone desiring to receive accident information. Accordingly, the posting and expiration dates, time, periods, are specifiable as well as a radius of the accident that any second vehicle must be within before having the message sent to them.

FIG. 4d illustrates a further method using the display 79 and other aspects of the user interface 51. In this example, an occupant in the first vehicle 26a can enter a message that includes a data instruction and other pertinent information concerning the establishment of a communication link between the first vehicle 26a and a second vehicle 26b when a user is within a predetermined range of a location point. The recipient information preferably constitutes people that may be affected by the message (user 2 in the second vehicle 26b). Because the message may also have pertinence to an instruction, the first vehicle 26a can also specify the type of instruction (place call to user 1 in the first vehicle 26a). A radius of a location point that any second vehicle must be within before establishing the communication link may also be specified in the message.

Messages and other pertinent message information can also be voice posted by the first vehicle 26a using voice recognition module 70 (see FIG. 2). In this regard, in one embodiment, the voice recognition module 70 (which also may constitute part of the controller 56) is employed to process a received voice in the vehicle and to match it to pre-stored voice prints stored in the voice recognition module 70. Many such voice recognition algorithms exist and are useable in the head unit 50, as one skilled in the art will appreciate. When a voice recognition module 70 is employed, message posting is made more convenient and less cumbersome, as an occupant in the vehicle can speak his message, the posting time, etc., and have it translated to text for eventual transmission to the second vehicle 26b. Moreover, the voice recognition module 70 may be used to verbally submit an intersection that is transmitted to the server 24 for translation into GPS or other latitude and longitude coordinates.

The message can also be posted an as audio or video message. Thus, at an appropriate time, the user interface 51 can prompt the user to speak the message he wants to send to the second vehicle 26b, which can be recorded using microphone 68. Additionally, a video of the user leaving the message can be taken using video camera 120, as shown in FIG. 5. Thus, instead of a text message, an audio or streaming video message can also be left for the second vehicle.

The message can also constitute a picture. For example, instead of informing the second vehicle 26b to pick up the prescription at the pharmacy, the message may instead constitute a simple picture of the pharmacy to be displayed on display 79 of the second vehicle's user interface 51 as a reminder. Such a picture can also be accompanied by a text or audio message. A picture can be taken using a camera coupled or coupleable to the user interface 51 in the first vehicle (not shown), and which may reside outside of the vehicle.

While it is deemed beneficial in a preferred embodiment to allow posting of the post time/expiration and time/date for the message, this is not strictly required, as the message can be posted immediately and indefinitely, or at least until the message is received by the second vehicle, as explained further below. Else, the message can simply “time out” after a set period and be deleted by the system.

In addition to any location information, the message sent from a user to the server 24 may also include a direction and a velocity of the user. This information may be obtained from the navigation unit 62, the positioning unit 6, or other vehicle sensors. This type of information can be helpful in specific cases such as accident notifications and third party requests as mentioned above.

In any event, once the message, the intended recipient, and other posting information (times, dates) are entered into the user interface 51 in the first vehicle 26a, such information is sent by the controller 56 to the vehicle bus 60, to the Telematics control unit 40, and ultimately to the server 24, which may constitute a communications server and is hereinafter referred to as a server. As shown in FIG. 6, the server 24 stores the message, along with the sending user's system ID code (user ID1), the recipient's system ID code (user ID2), and other message particulars such as the post/expiration time and date for the message. Other identity codes can also be used such as a phone number, a “handle,” a Vehicle Identification number (VIN), an Electronic Serial Number (ESN), an International Mobile Subscriber Number (IMSI), or a Mobile Subscriber International ISDN Number (MSISDN), all of which are referred to herein as “user IDs” for,convenience.

In a further embodiment, the location at which the message was posted by the first vehicle 26a (i.e., X1) is also stored with the message. Such location information may be automatically included with the posting by having the controller 56 query the navigation unit 62 (see FIG. 2) to receive the location of the first vehicle (i.e., its latitude/longitude coordinates). Alternatively, the server 24 may also determine or calculate location information about a specific user 26 based on information from various cellular base stations in the proximity of the user 26. This can be done by triangulating information such as signal strength of communications of the user with the plurality of cellular base stations. In any event, when wirelessly transmitting to the server 24, the message and any associated information may be formatted in any number of ways. For example, the message may constitute the bulk of the data stream, and may be accompanied by a header containing the user IDs, the posting data/time, etc., in predictable formats so they will be easily interpreted by the server 24. Once at the server 24, the information is preferably decompiled to understand the various pieces of information, and is stored in a file 122 as shown in FIG. 6.

However, it is not strictly necessary to send the exact location of the first vehicle at the time the message is posted by the first vehicle. For example, if the navigation unit 62 sends location information to the server 24 frequently enough, as described in further detail below, location information can be sent without the message. Instead, the server 24, upon receipt of the message, can query the last reported position of the first vehicle 26a and associate that location with the message. In this regard, the idea of sending a message and location information to the server 24 should be understood not to necessarily require simultaneous transmission of the two.

At this point, the server 24 may calculate other information which will be useful in eventually getting the message to the second vehicle 26a. For example, although it is desired to eventually send the message to the second vehicle 26b when it arrives at the posted location X1, the second vehicle may not arrive exactly at that location. Thus, it is preferred to eventually send the message to the second vehicle 26b when that vehicle is merely near to the location X1. The server 24 may therefore compute an area around the location (X1) posted by the first vehicle 26a to define and store a message area, as is shown in FIG. 6. The area can constitute a subset of locations (i.e., longitude/latitude data), and may be defined either by a radius around the location (125, FIG. 3) or an area of some other shape such as a square or rectangle (126, FIG. 3). The area may also be defined as a corridor upstream and downstream along a route or as a segment of highway or street. If the communication system is broken up into a grid, the location X1 can also be associated to an appropriate grid square (such as 126). Such a radius or area can also be specified by the first vehicle 26a and transmitted to the system 24 to allow the first vehicle to tailor the reception area for the message.

Additionally, the area prescribed can be a function of the message class. For example, some messages from the first user can constitute emergencies (car broken down), work-related messages (here's where the meeting is), and purely personal or recreational messages (let's stop here to eat). Accordingly, the first vehicle 26a can also allow selection of a message class indicator along with the message (e.g., priority “high,” “medium,” or “low”), with the area prescribed for receipt by the second vehicle 26b of the message scaling as a function of these message classes (“large,” “medium,” or “small”).

In one embodiment, the locations of vehicles 26a and 26b (and any other users connected to the system 10) are tracked by the server 24. In this regard, the Telematics control unit 40 automatically transmits to the server 24 the information regarding the location and identity of the vehicles on a periodic basis. Location information is provided by the navigation unit 62 (FIG. 2). Identity information can constitute a user ID for the user in the first vehicle who is logged on to the system, or a phone number, a “handle,” a Vehicle Identification number (VIN), an Electronic Serial Number (ESN), an International Mobile Subscriber Number (IMSI), or a Mobile Subscriber International ISDN Number (MSISDN) as noted earlier. In another embodiment, the server 24 tracks the location of vehicles 26a and 26b using information received from cellular base stations to triangulate the position of particular vehicles.

Because the location and identity of the vehicles or users are known to the server 24, the server 24 can query the stored messages to determine when message's recipients are in an appropriate location to receive the message, whereafter it is broadcast. Thus, when the second user has approached the stored location X1 and/or the message area (125) around it, and if the time and or date are appropriate as specified with the message, the message can be broadcast to the second user accordingly. The message can be wirelessly sent to the second user in the second vehicle 26b in much the same way that it was sent by the first vehicle 26a, structured with an appropriate and perhaps similar header. Of course, the second user need not receive all of the information sent by the first vehicle (e.g., the location information), although receipt of other information such as the sending user's ID can be of benefit as described below.

Alternatively, the server 24 can immediately transmit the message to the second vehicle and the second vehicle 26b would then be responsible for determining when the second vehicle 26b has approached the stored location X1 and/or the message area (125) around it, and if the time and or date are appropriate as specified with the message, the message can be displayed within the second vehicle accordingly.

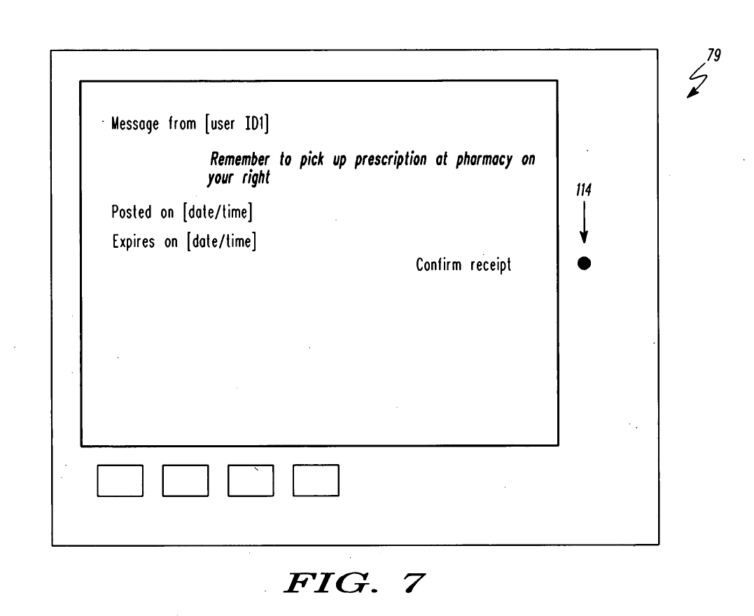

In any event, the message can be received at the user interface 51 of the second vehicle 26b in any number of ways. For example, as shown in FIG. 7, the message, if textual, can be displayed on the display 79 of the second vehicle's user interface, perhaps with some sort of visual or audible cue to be broadcast through the speakers 79, such as a “beep.” Other useful information, such as the post/expiration time or day can also be displayed. Additionally, the display can prompt the second vehicle to acknowledge receipt of the message by pressing a button 114, or such confirmation can be automatically sent after the message has been displayed for some time. When confirmation is received by the server 24, the message may be deleted there, although it can remain stored in the memory 64 of the second vehicle's 26b head unit 50 for some time to allow it again to be reviewed again by the second vehicle if necessary. In a further embodiment, the server 24 may send a notification to the first user or vehicle 26a notifying the user that the message was received by the second user or vehicle 26b.

The controller 56 of the second vehicle's user interface 51 can first display or broadcast a message notification indicator before the message is displayed or broadcast to allow the operator of the second vehicle 26b to prepare for the receipt of the message. If beneficial, such a message notification indicator can be selected by the occupant in the second vehicle 26b to actually display or broadcast the message, perhaps by pressing a dedicated button on the user interface 51. This way, the second vehicle does not have to actually receive the message until a time that is convenient. Additionally, the user interface 51 at the second vehicle may require the second vehicle to enter a personal identification code such as a Personal Identification Number (PIN) prior to receiving the message. Such a PIN, like other aspects in the system, can be entered textually, by pressing buttons, or by voice recognition. Upon validation of the PIN at the server 24 (or at the controller 56), the message can be sent by the server 24 to the user interface 51, or if already sent, can be enabled for display or broadcast.

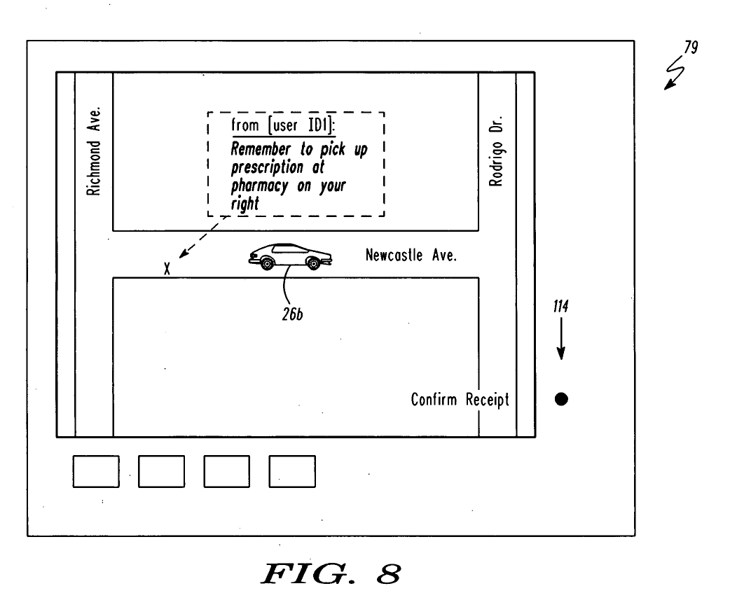

FIG. 8 shows another way in which the user can be notified of the message. In this embodiment, the message is superimposed on a map, such as a directional map that the second user might otherwise be using to navigate. As the second vehicle 26b approaches the location (X1), the message will appear, assuming the time and date are appropriate. The map may be provided by the second vehicle's 26b head unit 50, if so equipped with such a program. Otherwise, a map displaying the location can be formulated by the server 24 and sent along with the message, which saves the trouble of the second vehicle having to formulate a map and to associate it with the location in the message. Obviously, such a modification is particular beneficial if the second vehicle 26b is unable to formulate its own map.

The message can also be audibly (through speakers 78) or visually (on display 79) broadcast at the user interface 51 in the second vehicle 26b, which is particularly useful if the message is an audio message or a video message as discussed earlier. Such broadcast may also be accompanied by displaying of other useful information on the display 79 such as shown in FIG. 7.

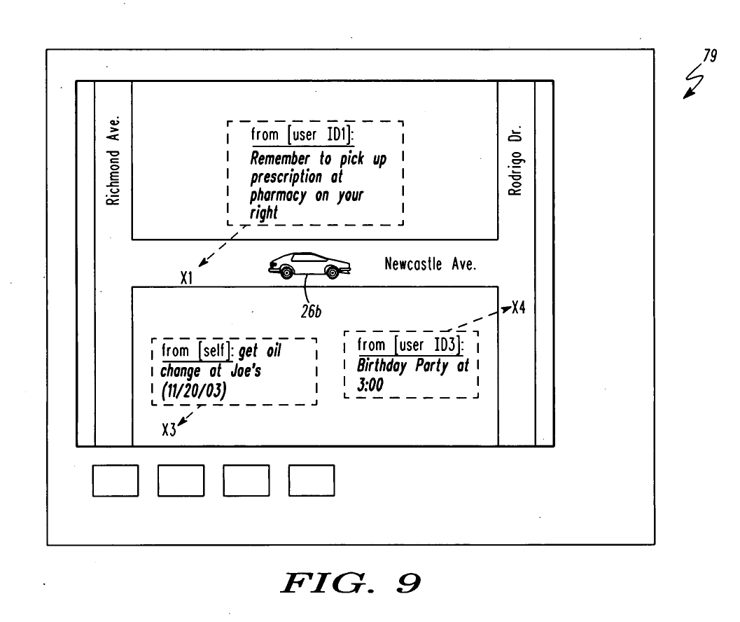

Although it is particularly beneficial to display or broadcast the message to the second vehicle 26b when it is in the vicinity of the location specified in the message, the second vehicle 26b may wish to know what messages have been posted to him even prior to his arrival at those locations. Accordingly, messages posted for the second vehicle can be sent even in advance of the second vehicle approaching the location of interest (e.g., X1), as shown in FIGS. 9-11. As shown in FIG. 9, three such messages have been posted for receipt at the user interface 51 of the second vehicle 26b and are superimposed on a map to show the locations where the messages are pertinent. When the second vehicle 26b moves into vicinity of those messages, the messages may change in color or otherwise become more pronounced; or, an audible alarm may sound; or confirmation of receipt of the message may be sent at that time.

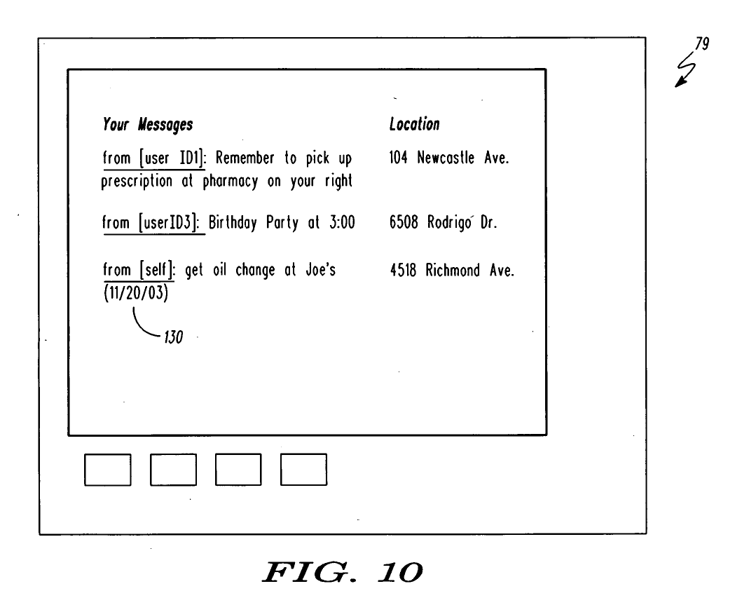

The second vehicle's messages can also be displayed in simple text form along with their location data, as shown at FIG. 10. Because displaying raw location information (longitude/latitude data) in this circumstance is less informative than when a map is used (FIG. 9), location information may be simplified by the server 24 by displaying, for example, a street address. In this regard, a mapping program can be implemented on the server 24 to effectuate a location data-to-street address conversion, as one skilled in the art understands.

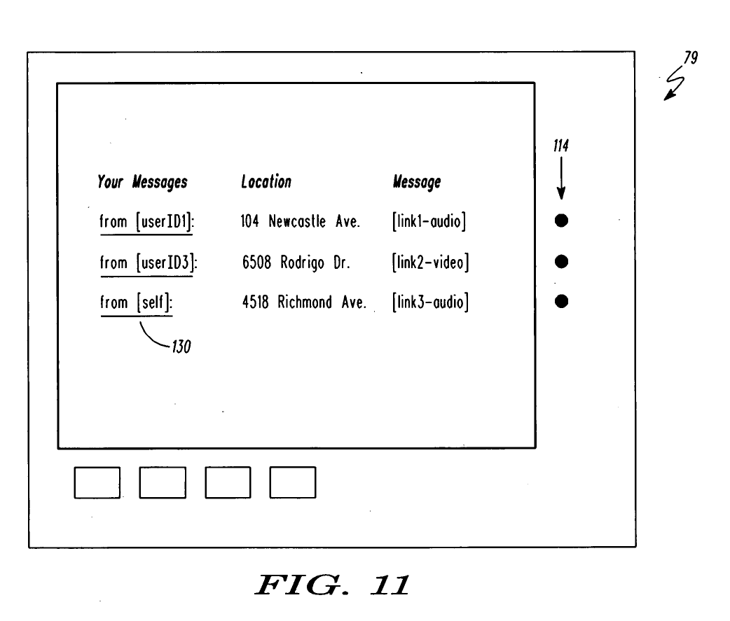

The second vehicle's messages, should they be audio or video messages, can be displayed as links, as shown in FIG. 11 so that they may be reviewed even in advance of arrival at the locations of interest. The links may be selected using selection buttons 114. Of course, these messages are preferably also broadcast when the second vehicle 26b arrives at the location specified by the first user.

FIGS. 9-11 also illustrate another flexible aspect of the disclosed message posting system, namely the ability of a user to leave a location-based message for himself rather than another system user. This is illustrated as message 130, in which the second vehicle 26b has left a message for himself at location X3. This can be accomplished in much the same way as the first vehicle 26a leaves a message for the second vehicle 26b. Essentially, the second vehicle 26b travels to the location (X3) and posts a message specifying his own user address, using any of the techniques disclosed earlier (e.g., FIGS. 4a-4c). This way the second vehicle (or any other user of the system) can leave a location-based message for themselves. For example, in the example of FIGS. 9-11, the second user, while driving passed the service station at location X3 might decide that he needs to remember to get his oil changed in the next couple of weeks, and accordingly can leave himself a message which will post at an appropriate date or time period two weeks in the future.

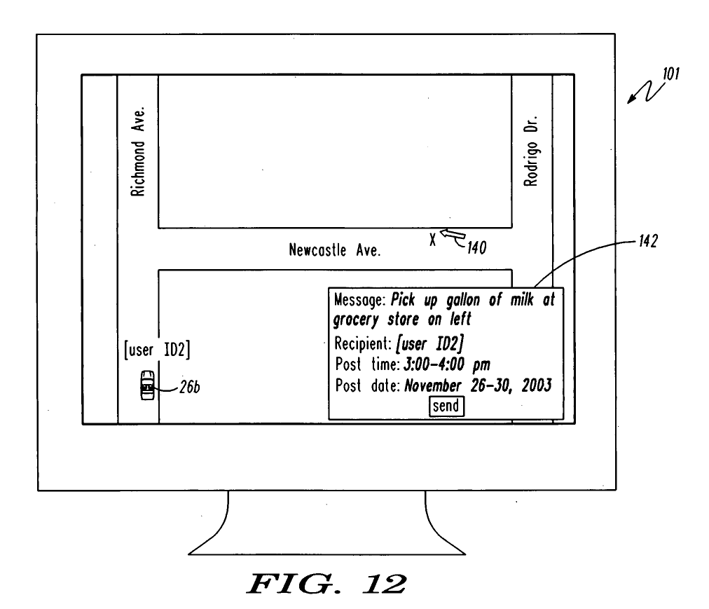

To this point, this disclosure has described embodiments in which a user travels to a particular location to post a message for himself or another user at that location. However, in other embodiments, a user of the system 10 need not be present at a location to leave a message for himself or another user at that location. This aspect is illustrated by again referring to FIG. 3, in which a system user located at a house 100 posts a message for the second vehicle 26b using a computer 101. In this example, the home user wishes to instruct the second vehicle to pick up a gallon of milk from the grocery store 104 (FIG. 3) located at X2. Posting of such a message can be done in a number of ways, as illustrated by the computer's 101 monitor in FIG. 12. For example, a map of an area can be pulled up on the monitor by the home user. The home user can then use a mouse pointer 140 to point to the location where the message is to be left (denoted by an X). After clicking this position, a window 142 can be made to pop up on the monitor, which contains blanks for the home user to input (e.g., type on a keyboard associated with the computer 101) the message and other message particulars, such as expiration time and date. Alternatively, the home user could first type in the second vehicle's user ID ([user ID2]), to first locate the second vehicle and display that location on the map. (This is feasible because, as noted earlier, in a preferred embodiment all users on the system periodically report in to the server 24 with identity and location information). If the second vehicle 26b is displayed, his user ID may be displayed above a representation of that vehicle as shown, and instead of having to type in the second vehicle's user ID, the home user may merely click on that representation to load it into window 142. Either way, once the location (X) and the message and its particulars are entered, the message can be sent to the server 24 (and ultimately the second vehicle 26b) by moving the pointer 140 to the “send” button and clicking it.

Of course, a non-mobile home user who anticipates being mobile at a later time can also leave message for himself by entering his own user ID into the computer 101.

Although illustrated with respect to an essentially non-mobile home user, mobile system users can also leave messages for others (or themselves) at locations where they are not located. In this regard, the controllers 56 in the user interfaces 51 in the vehicles could be made to run the same program as illustrated in FIG. 12 for the home user. Or the techniques disclosed earlier for posting of a message from a vehicle can be used, with the added aspect of also having to disclose the location of interest where the message should be posted.

Although the disclosed system and method are illustrated as being useful to leave a message with a single system user, it is also possible to leave a single message with numerous users, assuming their user IDs are also specified when the message is posted. Moreover, a single message to a single participant can be associated with a number of locations. This feature might be useful for example if the recipient needs to go to one of a particular chain of stores.

While largely described with respect to improving communications within vehicles, one skilled in the art will understand that many of the concepts disclosed herein could have applicability to other portable communicative user interfaces not contained within vehicles, such as cell phones, personal data assistants (PDAs), portable computers, etc., what can be referred to collectively as portable communication devices.

Although several discrete embodiments are disclosed, one skilled in the art will appreciate that the embodiments can be combined with one another, and that the use of one is not necessarily exclusive of the use of other embodiments. Moreover, the above description of the present invention is intended to be exemplary only and is not intended to limit the scope of any patent issuing from this application. The present invention is intended to be limited only by the scope and spirit of the following claims.

1. A method for allowing a first user to leave a message for at least one of a plurality of second users using a communication network, wherein the first user has a first user interface and each second user has a second user interface, comprising:
having the first user travel to a location with the first user interface;
having the first user use the user interface at the location to send to the communication network:
a message to at least one second user, and
data indicative of the location;
having the communication network send the message to the at least second user at his second user interface upon confirmation that the second user is substantially near the location.

2. The method of claim 1, wherein the first user interface further sends the second user's identification code to the communication network, and wherein the communication network sends the message upon confirmation of the second user's identification code.

3. The method of claim 2, wherein the identification code for the second user is selected from the group consisting of a phone number, a handle, a Vehicle Identification number (VIN), an Electronic Serial Number (ESN), an International Mobile Subscriber Number (IMSI), or a Mobile Subscriber International ISDN Number (MSISDN).

4. The method of claim 1, wherein the message selected from the group consisting of at least one of a text message, an audio message, a video message, a map, a picture, or a data instruction.

5. The method of claim 4, wherein the data instruction includes establishing a communication link between the farst user and the second user.

6. The method of claim 1, wherein the second user is substantially near the location when the second user is within a prescribed area around the location.

7. The method of claim 6, wherein the area is defined by a radius around the location.

8. The method of claim 6, wherein the area is a function of the message class.

9. The method of claim 1, wherein at least one of the first and second user interfaces is integral with a vehicle.

10. The method of claim 1, wherein at least one of the first and second user interfaces comprises a portable computer.

11. The method of claim 1, wherein the second user interface comprises a display, and wherein the display displays the message sent by the communication network.

12. The method of claim 1, wherein sending the message to the second user interface comprises first sending a message notification.

13. The method of claim 12, wherein the second user enters a personal identification code into the second user interface in response to the message notification to allow the message to be displayed or broadcast.

14. The method of claim 12, further comprising having the second user access the message notification on the second user interface to receive the message.

15. The method of claim 1, wherein the second user interface comprises a display containing a map, and wherein the location corresponding to the message is displayed on the map.

16. The method of claim 1, further comprising having the communication network send confirmation to the first user interface that the second user has received the message.

17. The method of claim 1, wherein the first user further sends to the communication network, along with the message and data indicative of the location, a direction and a velocity of the first user.

18. The method of claim 1, further comprising sending from the second user interface confirmation to the communication network that the message has been received by the second user.

19. The method of claim 18, wherein the communication network deletes the message upon receipt of the confirmation the second users.

20. The method of claim 1, wherein the first user further sends to the communication network along with the message and data indicative of the location a time or date period, and wherein the message is sent to the second user interface during that time or date period.

21. The method of claim 1, wherein the first user further sends to the communication network along with the message and data indicative of the location an expiration time or date, and wherein the message is only sent to the second user interface prior to that expiration time or date.

22. The method of claim 1, wherein the first user interface and the second user interface are in wireless communication with the communication network.

23. A method for allowing a user to leave a message for himself at a location using a user interface, comprising:
having the user send to the communication network at a first time:
a message, and
data indicative of the location;
having the communication network send the message to the user interface upon confirmation that the user is substantially near the location at a second time later than the first time.

24. The method of claim 23, wherein the first user is remote from the location.

25. The method of claim 23, wherein the user interface further sends the user's identification code to the communication network, and wherein the communication network sends the message upon confirmation of the user's identification code.

26. The method of claim 25, wherein the identification code is selected from the group consisting of a phone number, a handle, a Vehicle Identification number (VIN), an Electronic Serial Number (ESN), an International Mobile Subscriber Number (IMSI), or a Mobile Subscriber International ISDN Number (MSISDN).

27. The method of claim 23, wherein the message selected from the group consisting of at least one of a text message, an audio message, a video message, a map, or a picture.

28. The method of claim 23, wherein the user is substantially near the location when the second user is within a prescribed area around the location.

29. The method of claim 28, wherein the area is defined by a radius around the location.

30. The method of claim 28, wherein the area is a function of the message class.

31. The method of claim 23, wherein the user interface is integral with a vehicle.

32. The method of claim 23, wherein the user interface comprises a portable computer.

33. The method of claim 23, wherein the user interface comprises a display, and wherein the display displays the message sent by the communication network.

34. The method of claim 23, wherein sending the message to the user interface comprises first sending a message notification.

35. The method of claim 34, wherein the user enters a personal identification code into the user interface in response to the message notification to allow the message to be displayed or broadcast.

36. The method of claim 34, further comprising having the user access the message notification on the user interface to receive the message.

37. The method of claim 23, wherein the user interface comprises a display containing a map, and wherein the location corresponding to the message is displayed on the map.

38. The method of claim 23, wherein the message is deleted by the communication network after a fixed period of time.

39. The method of claim 23, further comprising sending from the user interface confirmation to the communication network that the message has been received by the user.

40. The method of claim 39, wherein the communication network deletes the message upon receipt of the confirmation the user.

41. The method of claim 23, wherein the user further sends to the communication network along with the message and data indicative of the location a time or date period, and wherein the message is sent to the user interface during that time or date period.

42. The method of claim 23, wherein the user further sends to the communication network along with the message and data indicative of the location an expiration time or date, and wherein the message is only sent to the user interface prior to that expiration time or date.

43. The method of claim 42, wherein the user interface is in wireless communication with the communication network.

44. A method for allowing a first user to leave a message for at least one second user using a communication network, wherein the first user has a first user interface and the second user has a second user interface, comprising:
having the first user use the first user interface to send to the communication network:
a message to the second user, and
an identification code of the second user to the communication network;
having the communication network send the message, and data indicative of a location of the first user, to the second user interface;
wherein communication network sends the message upon confirmation of the second user's identification code.

45. The method of claim 44, wherein the identification code for the second user is selected from the group consisting of a phone number, a handle, a Vehicle Identification number (VIN), an Electronic Serial Number (ESN), an International Mobile Subscriber Number (IMSI), or a Mobile Subscriber International ISDN Number (MSISDN).

46. The method of claim 44, wherein the message selected from the group consisting of at least one of a text message, an audio message, a video message, a map, a picture, or a data instruction.

47. The method of claim 46, wherein the data instruction includes establishing a communication link between the first user and the second user.

48. The method of claim 44, wherein at least one of the first and second user interfaces is integral with a vehicle.

49. The method of claim 44, wherein at least one of the first and second user interfaces comprises a portable computer.

50. The method of claim 44, wherein the second user interface comprises a display, and wherein the display displays the message sent by the communication network.

51. The method of claim 44, wherein sending the message to the second user interface comprises first sending a message notification where the second user enters a personal identification code into the second user interface in response to the message notification to allow the message to be displayed or broadcast.

52. The method of claim 44, wherein the second user interface comprises a display containing a map, and wherein the location corresponding to the message is displayed on the map.

53. The method of claim 44, further comprising the step of having the communication network send confirmation to the first user interface that the second user has received the message.

54. The method of claim 44, wherein the message is deleted by the communication network after a fixed period of time.

55. The method of claim 44, further comprising sending from the second user interface confirmation to the communication network that the message has been received by the second user.

56. The method of claim 55, wherein the communication network deletes the message upon receipt of the confirmation the second user.

57. The method of claim 44, wherein the first user further sends to the communication network, along with the message, a time or date period, and wherein the message is sent to the second user interface during that time or date period.

58. The method of claim 44, wherein the first user further sends to the communication network, along with the message, an expiration time or date, and wherein the message is only sent to the second user interface prior to that expiration time or date.

59. The method of claim 44, wherein the message is displayed or broadcast to the second user at the second user interface when the second user is substantially near the location.

60. A method for allowing a user to leave a message for the user using a communication network, wherein the user has a user interface, comprising:
having the user use the user interface to send to the communication network:
a message to the user,
data indicative of the location, and
an identification code of the user to the communication network;
having the communication network send the message and the data indicative of the location to the user interface;
wherein communication network sends the message upon confirmation of the user's identification code.

61. The method of claim 60, wherein the identification code for the user is selected from the group consisting of a phone number, a handle, a Vehicle Identification number (VIN), an Electronic Serial Number (ESN), an International Mobile Subscriber Number (IMSI), or a Mobile Subscriber International ISDN Number (MSISDN).

62. The method of claim 60, wherein the message selected from the group consisting of at least one of a text message, an audio message, a video message, a map, or a picture.

63. The method of claim 60, wherein the user interface is integral with a vehicle.

64. The method of claim 60, wherein the user interface comprises a portable computer.

65. The method of claim 60, wherein the user interface comprises a display, and wherein the display displays the message sent by the communication network.

66. The method of claim 60, wherein the user interface comprises a display containing a map, and wherein the location corresponding to the message is displayed on the map.

67. The method of claim 60, wherein the message is deleted by the communication network after a fixed period of time.

68. The method of claim 60, further comprising the step of sending from the user interface confirmation to the communication network that the message has been received by the user.

69. The method of claim 60, wherein the communication network deletes the message upon receipt of the confirmation the user.

70. The method of claim 60, wherein the user further sends to the communication network along with the message and data indicative of the location a time or date period, and wherein the message is sent to the user interface during that time or date period.

71. The method of claim 60, wherein the first user further sends to the communication network along with the message and data indicative of the location an expiration time or date, and wherein the message is only sent to the second user interface prior to that expiration time or date.

72. The method of claim 60, wherein the message is displayed or broadcast to the user at the user interface when the user is substantially near the location.
